(19) United States
(12) Patent Application Publication
(10) Pub. No.: US 2022/0245478 A1
(43) Pub. Date: Aug. 4, 2022

(54) SYSTEM AND METHOD FOR DATA ANALYTICS USING SMOOTH SURROGATE MODELS

(71) Applicant: Chevron U.S.A. Inc., San Ramon, CA (US)

(72) Inventor: Julian A. Thorne, Houston, TX (US)

(21) Appl. No.: 17/164,081

(22) Filed: Feb. 1, 2021

(51) Int. Cl. G06N 5/04; G06N 5/00; G06N 20/20; G01V 99/00

(52) U.S. Cl. CPC G06N 5/04; G01V 99/005; G06N 20/20; G06N 5/003

(57) ABSTRACT

A method is described for data analytics including receiving a training dataset representative of a subsurface volume of interest with co-located measured explanatory features and a response feature; generating an ensemble of models using an ensemble of decision tree regressions; generating a surrogate model by fitting response surfaces of the ensemble of models with a power law combination of each of the explanatory features, and products and ratios of each pair of the explanatory features; receiving a second dataset of explanatory features from locations away from the co-located measured explanatory features, wherein the second dataset of explanatory features are a same type as the co-located measured explanatory features; and generating, using the surrogate model a smooth prediction of the response feature based on the second dataset of explanatory features. The method may be executed by a computer system.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The disclosed embodiments relate generally to techniques for data analytics and, in particular, to a method of data analytics using smooth surrogate models.

### BACKGROUND

Data analytics, alternatively called data mining or data science, uses optimization methods to fit non-linear functions of explanatory variables to a response variable. The most successful of these methods, as evaluated by their ability to win data science competitions, are classification and regression tree methods. Foremost among these are random forest and gradient boost methods. These methods perform well because they rely on variable cut-offs produce response surfaces that are not smooth but have many steps. Physics-based models, on the other hand, produce response surfaces that are, in general, smooth. These models are only possible when the physics of a problem is well understood but they give insight as to what should be preferred data science solutions: the insight being that the response surface steps in decision tree methods are most often artifacts that should be removed. Simple smoothing operations are not possible because the response surface is too high-dimensional causing the smoothing kernel to be poorly defined by limited data. Another insight from physics-based models is that the response surface is unlikely to have many turning points along the axis of any one dimension. The response along one axis may go up and then down but it is unlikely to go up and down then up then down etc. Data science methods do not penalize multiple turning points. Simple smoothing operations do not remove them either.

There is an opportunity to leverage smoothness for improved data analytics.

### SUMMARY

In accordance with some embodiments, a method of data analytics including receiving a training dataset representative of a subsurface volume of interest with co-located measured explanatory features and a response feature; generating an ensemble of models using an ensemble of decision tree regressions; generating a surrogate model by fitting response surfaces of the ensemble of models with a power law combination of each of the explanatory features, and products and ratios of each pair of the explanatory features; receiving a second dataset of explanatory features from locations away from the co-located measured explanatory features, wherein the second dataset of explanatory features are a same type as the co-located measured explanatory features; and generating, using the surrogate model a smooth prediction of the response feature based on the second dataset of explanatory features is disclosed.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates elements of a method of data analytics, in accordance with some embodiments; and

FIG. 2 is a block diagram illustrating a data analytics system, in accordance with some embodiments.

Like reference numerals refer to corresponding parts throughout the drawings.

### DETAILED DESCRIPTION OF EMBODIMENTS

Described below are methods, systems, and computer readable storage media that provide a manner of data analytics. The data analytics methods and systems provided herein may be used for prediction of hydrocarbon production.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

Hydrocarbon exploration and production results in a huge amount of data. This may include geological data, geophysical data, and petrophysical data. It may also include production data. Data analytics can extract meaning from this data in order to make predictions for identifying and producing hydrocarbons. For example, well-log petrophysical data and seismic attributes can be used to predict the observed variations in gas or oil production across a field or basin. Data analytic tools such as an ensemble of regression or classification decision trees can be trained on co-located well-logs, seismic, and production data to generate a prediction function. The prediction function is then applied on interpolated petrophysical property maps or volumes and the seismic attributes to predict the desired response variables such as estimated ultimate recovery. Since well completion parameters can also influence production, data analytics is also used to normalize out these effects.

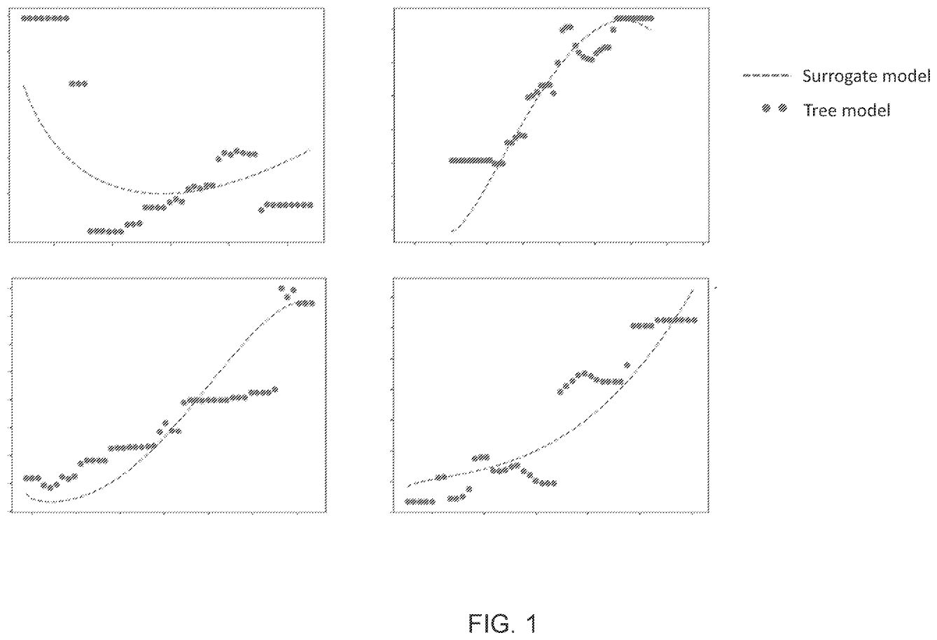

In this invention, a smooth surrogate model is fit to the model produced by an ensemble of decision trees or regression trees. The equation of the surrogate model is designed so that multiple turning points in the response function are not possible. As seen in FIG. 1, the response surface for the surrogate model for four different features is much smoother than that produced by the original, in this case, gradient-boosted regression tree model.

In an embodiment, an equation for the surrogate model is to fit a power law combination of each original feature, and products and ratios of each pair of features. A good optimization procedure for the weights in this equation is to first fit a linear combination and then to use the linear weights as a starting point in a general optimization using a power law for each component. The exponents in the power law are constrained so as to not introduce additional turning points in the function.

The surrogate model can be used to make a smooth more physical prediction from a new more spatially comprehensive set of the same explanatory features used in training.

The smooth predictions of a surrogate model are ideal data analytics products for a variety of important data-driven decisions in hydrocarbon exploration and production. For example, smooth maps of productivity are best for booking reserves or optimizing the drilling queue based on expected production. In exploration, smooth models are the best input into calculations of reservoir, seal, and source risk.

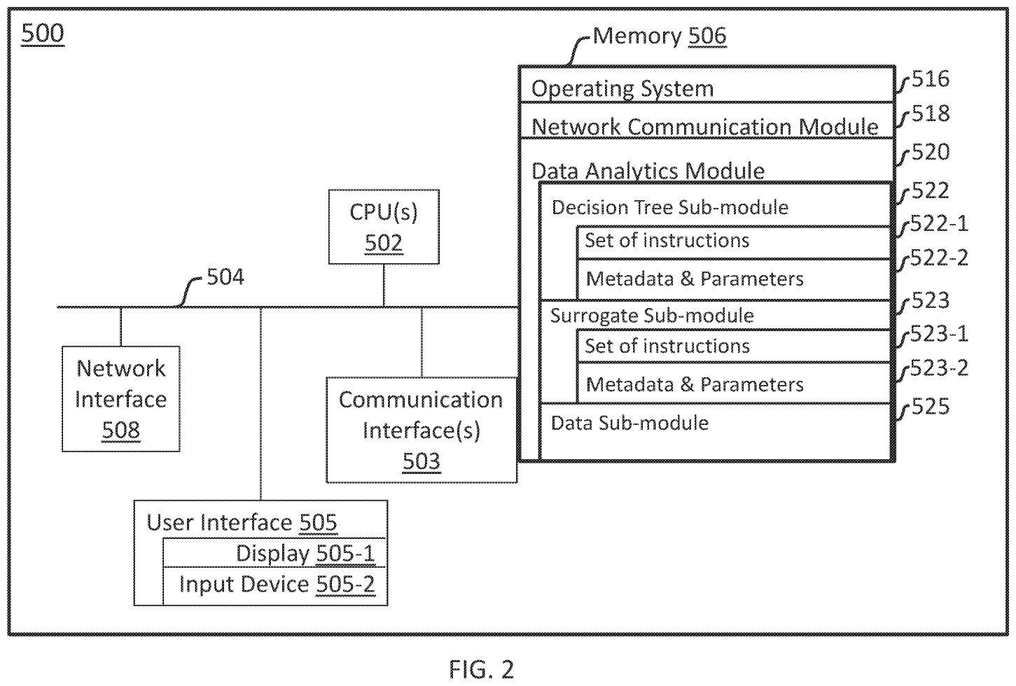

FIG. 2 is a block diagram illustrating a data analytics system 500, in accordance with some embodiments. While certain specific features are illustrated, those skilled in the art will appreciate from the present disclosure that various other features have not been illustrated for the sake of brevity and so as not to obscure more pertinent aspects of the embodiments disclosed herein.

To that end, the data analytics system 500 includes one or more processing units (CPUs) 502, one or more network interfaces 508 and/or other communications interfaces 503, memory 506, and one or more communication buses 504 for interconnecting these and various other components. The data analytics system 500 also includes a user interface 505 (e.g., a display 505-1 and an input device 505-2). The communication buses 504 may include circuitry (sometimes called a chipset) that interconnects and controls communications between system components. Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPUs 502. Memory 506, including the non-volatile and volatile memory devices within memory 506, comprises a non-transitory computer readable storage medium and may store data related to hydrocarbon exploration and production.

In some embodiments, memory 506 or the non-transitory computer readable storage medium of memory 506 stores the following programs, modules and data structures, or a subset thereof including an operating system 516, a network communication module 518, and a data analytics module 520.

The operating system 516 includes procedures for handling various basic system services and for performing hardware dependent tasks.

The network communication module 518 facilitates communication with other devices via the communication network interfaces 508 (wired or wireless) and one or more communication networks, such as the Internet, other wide area networks, local area networks, metropolitan area networks, and so on. The data analytics system 500 may be on a single device, multiple devices in a cluster, and/or be a cloud computing system.

In some embodiments, the data analytics module 520 executes the operations disclosed herein. Data analytics module 520 may include data sub-module 525, which handles the dataset including all available geological, geophysical, petrophysical, and production data. This data is supplied by data sub-module 525 to other sub-modules.

Decision tree sub-module 522 contains a set of instructions 522-1 and accepts metadata and parameters 522-2 that will enable it to calculate a decision tree model. The surrogate model sub-module 523 contains a set of instructions 523-1 and accepts metadata and parameters 523-2 that will enable it to calculate a surrogate model which is then used to make a smooth more physical prediction from a new more spatially comprehensive set of the same explanatory features used in training. Although specific operations have been identified for the sub-modules discussed herein, this is not meant to be limiting. Each sub-module may be configured to execute operations identified as being a part of other sub-modules, and may contain other instructions, metadata, and parameters that allow it to execute other operations of use in processing data and generating images. For example, any of the sub-modules may optionally be able to generate a display that would be sent to and shown on the user interface display 505-1. In addition, any of the data or processed data products may be transmitted via the communication interface(s) 503 or the network interface 508 and may be stored in memory 506.

The method described above is, optionally, governed by instructions that are stored in computer memory or a non-transitory computer readable storage medium (e.g., memory 506 in FIG. 2) and are executed by one or more processors (e.g., processors 502) of one or more computer systems. The computer readable storage medium may include a magnetic or optical disk storage device, solid state storage devices such as flash memory, or other non-volatile memory device or devices. The computer readable instructions stored on the computer readable storage medium may include one or more of: source code, assembly language code, object code, or another instruction format that is interpreted by one or more processors. In various embodiments, some operations in each method may be combined and/or the order of some operations may be changed from the order shown in the figures. For ease of explanation, the method is described as being performed by a computer system, although in some embodiments, various operations of the method are distributed across separate computer systems.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of data analytics, comprising:
a. receiving, at one or more computer processors, a training dataset representative of a subsurface volume of interest with co-located measured explanatory features and a response feature;
b. generating, via the one or more computer processors, an ensemble of models using an ensemble of decision tree regressions;
c. generating, via the one or more computer processors, a surrogate model by fitting response surfaces of the ensemble of models with a power law combination of each of the explanatory features, and products and ratios of each pair of the explanatory features;
d. receiving, at the one or more computer processors, a second dataset of explanatory features from locations away from the co-located measured explanatory features, wherein the second dataset of explanatory features are a same type as the co-located measured explanatory features; and
e. generating, using the surrogate model, via the one or more computer processors, a smooth prediction of the response feature based on the second dataset of explanatory features.

2. The method of claim 1 wherein the fitting the response surfaces of the ensemble of models comprises fitting a linear combination and using the linear combination as a starting point in a general optimization using a power law for each component.

3. The method of claim 2 wherein exponents in the power law are constrained to not introduce additional turning points.

4. The method of claim 1 wherein the co-located measured explanatory features are derived from one or more of co-located well-log data, seismic data, and production data.

5. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive, at the one or more processors, a training dataset representative of a subsurface volume of interest with co-located measured explanatory features and a response feature;
b. generate, via the one or more processors, an ensemble of models using an ensemble of decision tree regressions;
c. generate, via the one or more processors, a surrogate model by fitting response surfaces of the ensemble of models with a power law combination of each of the explanatory features, and products and ratios of each pair of the explanatory features;
d. receive, at the one or more processors, a second dataset of explanatory features from locations away from the co-located measured explanatory features, wherein the second dataset of explanatory features are a same type as the co-located measured explanatory features; and
e. generate, using the surrogate model, via the one or more computer processors, a smooth prediction of the response feature based on the second dataset of explanatory features.

6. The system of claim 5 wherein the fitting the response surfaces of the ensemble of models comprises fitting a linear combination and using the linear combination as a starting point in a general optimization using a power law for each component.

7. The system of claim 6 wherein exponents in the power law are constrained to not introduce additional turning points.

8. The system of claim 5 wherein the co-located measured explanatory features are derived from one or more of co-located well-log data, seismic data, and production data.

9. A non-transitory computer readable storage medium storing one or more programs, the one or more programs comprising instructions, which when executed by an electronic device with one or more processors and memory, cause the device to
a. receive, at the one or more processors, a training dataset representative of a subsurface volume of interest with co-located measured explanatory features and a response feature;
b. generate, via the one or more processors, an ensemble of models using an ensemble of decision tree regressions;
c. generate, via the one or more processors, a surrogate model by fitting response surfaces of the ensemble of models with a power law combination of each of the explanatory features, and products and ratios of each pair of the explanatory features;
d. receive, at the one or more processors, a second dataset of explanatory features from locations away from the co-located measured explanatory features, wherein the second dataset of explanatory features are a same type as the co-located measured explanatory features; and
e. generate, using the surrogate model, via the one or more computer processors, a smooth prediction of the response feature based on the second dataset of explanatory features.

10. The device of claim 9 wherein the fitting the response surfaces of the ensemble of models comprises fitting a linear combination and using the linear combination as a starting point in a general optimization using a power law for each component.

11. The device of claim 10 wherein exponents in the power law are constrained to not introduce additional turning points.

12. The device of claim 9 wherein the co-located measured explanatory features are derived from one or more of co-located well-log data, seismic data, and production data.
